(19) United States
(12) Patent Application Publication
(10) Pub. No.: US 2008/0156444 A1
(43) Pub. Date: Jul. 3, 2008

(54) Tape and Masking Material Composite

(75) Inventors: James F. Pitzen, Stillwater, MN (US); Joseph T. Bartusiak, Osseo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/617,004

(22) Filed: Dec. 28, 2006

(51) Int. Cl. B32B 38/00; B32B 3/06

(52) U.S. Cl. 156/510; 428/99

(57) ABSTRACT

A tape and masking material composite including a sheet of masking material, and a length of pressure sensitive adhesive coated tape adhered to a first surface along a first edge of the sheet of masking material with the tape having a longitudinal pressure sensitive adhesive covered portion extending past the first edge of the sheet of masking material. The masking material has removable pressure sensitive adhesive on a second major surface opposite its first major surface at least including on and along a portion of that second surface along a second edge opposite its first edge.

### FIELD OF THE INVENTION

The present invention relates to tape and masking material composites, and to dispensers from which such tape and masking material composites may be formed and/or dispensed so that the tape and masking material composite can be temporarily adhered to a surface to mask that surface, such as during painting of adjacent surfaces.

### DESCRIPTION OF THE RELATED ART

Dispensers are known that either (1) adhere a length of pressure sensitive adhesive coated tape along an edge of a sheet of masking material with the tape having a longitudinal pressure sensitive adhesive covered portion extending past that edge of the sheet of masking material to make a tape and masking material composite as that composite is pulled from the dispenser (e.g., the dispenser described in U.S. Pat. No. 4,990,214); or (2) contain a roll of such a tape and masking material composite from which the composite can be pulled (e.g., the dispenser described in U.S. Pat. No. 6,575,345), which dispenser includes a cutting blade that can sever a dispensed length of the tape and masking material composite after it is pulled from the dispenser. The tape and masking material composites from such dispensers are typically used to mask a surface during painting of adjacent surfaces. Under some circumstances the sheet of masking material in that composite can become displaced from over the surface it is intended to protect, thereby allowing contamination of that surface by paint spray or splatters. This can occur, for example, when the tape and masking material composite is applied outdoors and wind gets under the edge of the sheet of masking material opposite the tape, or when that masking material composite is applied indoors and an edge portion of the sheet of masking material opposite the tape is displaced by air currents generated by a spraying device. In some such instances, to overcome these problems, users of the tape and masking material composite have resorted to taping down the edge portion of the sheet of masking material opposite the tape, or resorted to setting weights on it.

### SUMMARY OF THE INVENTION

The present invention provides a tape and masking material composite which restricts displacement of the edge portion of the sheet of masking material opposite the tape because of wind, contact by a person or object, or air disturbance.

According to the present invention there is provided a tape and masking material composite comprising an elongate sheet of masking material, a length of pressure sensitive adhesive coated tape adhered to a first surface and along a first edge of the sheet of masking material with the tape having a longitudinal pressure sensitive adhesive covered portion extending past the first edge of the sheet of masking material, which masking material has removable pressure sensitive adhesive on a second major surface opposite its first major surface, the removable pressure sensitive adhesive being at least on a portion of the second surface along a second edge of the masking material opposite its first edge.

The removable pressure sensitive adhesive on the masking material can restrict displacement of the masking material because of wind or contact by a person or object, and can also provide advantageous adhesion of the masking material to other covering materials, such as to a drop cloth on the floor when the tape and masking material composite is used to mask a baseboard along walls to be painted.

The removable pressure sensitive adhesive on the masking material can be in stripes, in spaced dots, or in other configurations on the second surface of the sheet of masking material, and should extend over at least twenty five percent or fifty percent of the second surface of the sheet of masking material. The removable pressure sensitive adhesive can extend entirely over the second surface of the sheet of masking material which could be advantageous for some applications.

The tape and masking material composite can be provided in a roll which includes a core having an outer surface about which an innermost wrap of the roll of tape and masking material composite is wrapped, and can be provided in combination with a dispenser of the type comprising a housing including means adapted for manual engagement, means for mounting the roll of tape and masking material composite for rotation about its axis relative to the housing, and means for severing a length of the tape and masking material composite manually withdrawn from the roll from the tape and masking material composite remaining in the roll (e.g., the dispenser described in U.S. Pat. No. 6,575,345).

Alternatively, the tape and masking material composite can be formed by a dispenser that adheres a length of the tape along the first edge of the sheet of masking material so that the tape has a longitudinal pressure sensitive adhesive covered portion extending past that first edge of the sheet of masking material to make the tape and masking material composite as that composite is pulled from the dispenser (e.g., the dispenser described in U.S. Pat. No. 4,990,214).

Either of those dispensers can also be used to dispense only masking material having removable pressure sensitive adhesive on its second major surface from a roll of the masking material without having or applying the length of tape along its first edge, in which case the removable pressure sensitive adhesive should at least be on portions of that second surface along both the first and second edges of the masking material, and could extend over the entire second surface of the masking material.

### BRIEF DESCRIPTION OF THE DRAWING

The present invention will be further described with reference to the accompanying drawing wherein like reference numerals refer to like parts in the several views, and wherein:

FIG. 1 is a perspective view of the combination of a first type of dispenser, a roll of tape, and a roll of masking material mounted on the dispenser by which a tape and masking material composite according to the present invention can be formed;

FIG. 2 is an enlarged view taken along the line 2-2 of FIG. 1 of the tape and masking material composite formed by the combination shown in FIG. 1;

FIGS. 3 and 4 are end views of two alternate tape and masking material composites that can be formed by the combination shown in FIG. 1;

FIG. 5 is a perspective view of the combination of a roll of a tape and masking material composite according to the present invention and a second type of dispenser by which the tape and masking material composite can be dispensed; and

FIG. 6 is an end view of a masking material that could be dispensed from either of the dispensers shown in FIGS. 1 and 5.

### DETAILED DESCRIPTION

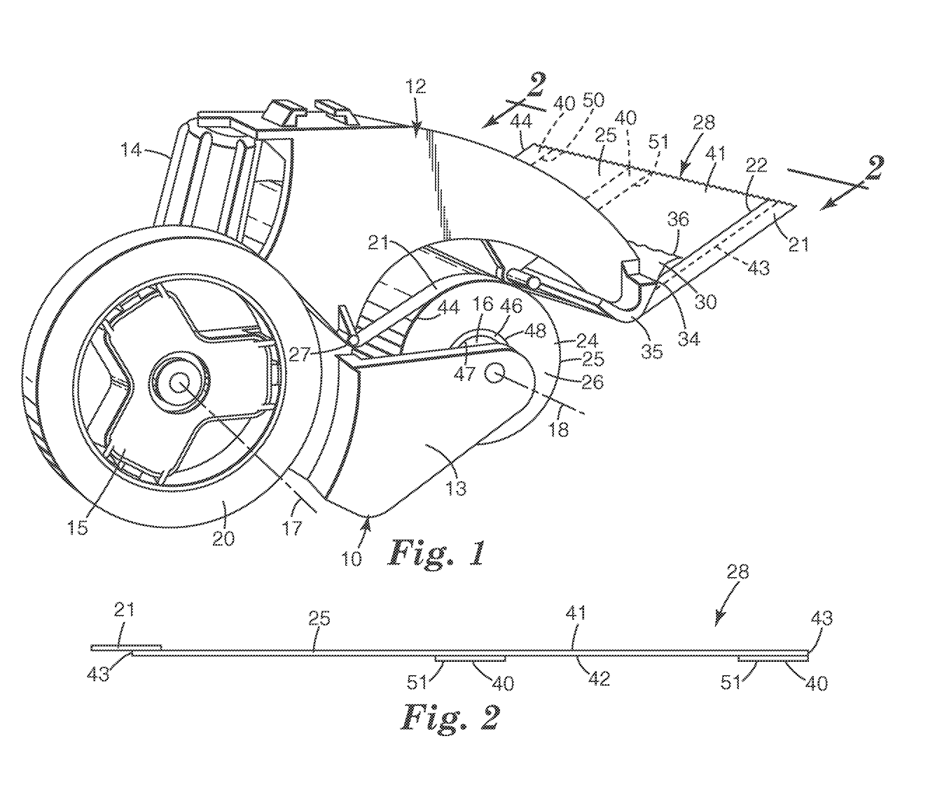

Referring now to FIGS. 1 and 2 of the drawing, there is shown a combination of a roll 24 of masking material 25 having removable pressure sensitive adhesive 40 on a second major surface 42, a roll 20 of pressure sensitive adhesive coated tape 21 (e.g., the masking tape sold under the trade designation “SCOTCH (t.m.) Safe Release (t.m.) Painters Masking Tape For Painted Surfaces and Glass, #2090” by 3M Company, St. Paul, Minn.) and a portable dispenser 10 for use in dispensing a length or sheet of masking material 25 and a length of the tape 21 from those rolls 24 and 20 while the dispenser 10 adheres the tape 21 to a first major surface 41 and along a first edge 43 of the sheet of masking material 25 with the tape 21 having a longitudinal pressure sensitive adhesive covered portion extending past the first edge 43 of the sheet of masking material 25 to form a tape and masking material composite or laminate 28 according to the present invention.

The roll 24 of masking material 25 comprises a stiff cylindrical core 46 having a cylindrical inner surface 47 defining a through opening, the masking material 25 which is an elongate thin sheet of flexible conformable material that restricts absorption of liquids applied to its first major surface 41 (e.g., fibrous or polymeric material such as the fibrous masking material sold under the trade designation “3M Handmasker (t.m.) Premium Quality Masking Paper” by 3M Company, St. Paul, Minn., or the polymeric material sold under the trade designation “3M Handmasker (t.m.) Prefolded Masking Film Plus” by 3M Company, St. Paul, Minn.); and the removable pressure sensitive adhesive 40 on the second major surface 42 of the masking material 25. The removable adhesive 40 is of a type that can be securely adhered to most surfaces including rough vertical support surfaces, such as those of painted walls or cement blocks, while affording clean removal of the masking material from all surfaces without leaving adhesive residue or damaging the surface such as by removing paint, paper, or fabric from the surfaces. The removable adhesives described in U.S. Pat. No. 3,691,140 (Silver), U.S. Pat. No. 3,857,731 (Merrill et al), U.S. Pat. No. 4,166,152 (Baker et al) and U.S. Pat. No. 5,045,569 (Delgado) may be suitable (the content of those patents being incorporated herein by reference). The masking material 25 is helically coiled about a cylindrical outer surface 48 of the core 46 with the removable adhesive 40 adjacent the core 46.

The dispenser 10 is of the type described in U.S. Pat. No. 4,990,214 (the content whereof is incorporated herein by reference), one embodiment of which is sold by Minnesota Mining and Manufacturing Company, St., Paul, Minn. under the trade designation “HandMasker”(t.m.) M3000 Dispenser. Generally, that dispenser 10 includes a polymeric frame 12 including a hub support frame member 13 and a handle 14 adopted for manual engagement to manipulate the dispenser 10. First and second hubs 15 and 16 are mounted on the hub support frame member 13 for rotation about spaced generally parallel axes 17 and 18. The first hub 15 (described more fully in U.S. Pat. No. 5,667,626, the content whereof is incorporated herein by reference) can receive the roll 20 of tape 21 that (as noted above) can be applied by the dispenser 10 along the first edge 43 of the masking material 25 withdrawn from the roll 24 of masking material 25 to form the tape and masking material composite 28. The first hub 15 and means on the frame 12 for guiding the tape 21 to the roll 24 of masking material 25 are adapted to position a first edge 22 of a length of the tape 21 withdrawn from the roll 20 at a first predetermined position axially with respect to the first and second hubs 15 and 16 with the opposite second edge of that withdrawn length of tape 21 projecting past the first end 26 of the toll of masking material 25. The second hub 16 is adapted to receive the roll 24 of masking material 25 and to position the first end 26 of the roll 24 of masking material 25 at a second predetermined position axially with respect to the first and second hubs 15 and 16 with the width of the length of tape 21 extending from the first position past the second position and the roll 24 of masking material 25 extending from the second position past the first position. A portion of the length of tape 21 along the first edge 22 of the length of tape 21 and a portion of the length of masking material 25 along the first end 26 of the roll 24 of masking material 25 are both positioned between those first and second positions. The dispenser 10 includes means including a guide pin 27 that helps define the path for the length of tape 21 from the roll 20 of tape 21 to the periphery of the roll 24 of masking material 25 where the portion of tape 21 along the first edge 22 of the length of tape 21 is adhered to the portion of the masking material 25 along the first end 26 of the roll 24 of masking material 25. Such adhesion of the tape 21 to the masking material 25 along the periphery of the roll 24 of masking material 25 forms the tape and masking sheet composite 28 having opposite edges defined by the second edges of the length of tape 21 and the length of masking material 25 and an exposed portion of the coating of pressure sensitive adhesive along the second edge on the length of tape 21 along one major surface of the tape and masking material composite 28 so that the exposed portion of the coating of adhesive can be adhered along a surface to be masked to hold the tape and masking sheet composite 28 in a desired position.

The second hub 16 (described more fully in U.S. Pat. No. 4,379,019 with reference to FIG. 10 of that patent, the content whereof is incorporated herein by reference) is adapted to be inserted into the through opening through the core 46 from one end of the core 46 and to frictionally engage the inner surface 47 of the core 46 that defines its through opening to mount the roll 24 of masking material 25 on the frame 12 of the dispenser 10 for co-axial rotation together of the second hub 16 and the roll 24 of masking material relative to the frame 12.

The frame 12 defines a path or passageway on the device 10 through which a person may pull the tape and masking material composite 28 from the roll 20 of tape 21 and the roll 24 of masking material 25.

The dispenser 10 includes a cut off blade assembly comprising a thin metal blade 30 (e.g., made of 0.018 inch thick sheet steel). The metal blade 30 includes an attachment portion 34 that is curved along its length to have a generally J-shaped cross section and is removeably attached to a portion 35 of the frame 12. The cut off blade 30 extends generally parallel to the axes 17 and 18 of the hubs 15 and 16 and defines a first side of the passageway on the dispenser 10 through which a person may pull the tape and masking material composite 28 from the dispenser 10. A user of the dispenser 10 can manually tension the tape and masking material composite 28 being pulled from the dispenser 10 around a row of similarly shaped projecting teeth 36 included in the blade 30. The teeth 36 will then pierce and transversely sever the tensioned tape and masking material composite 28 along the teeth 36 on the blade 30 as that tape and masking material composite 28 is pulled away from the dispenser 10.

The teeth 36 on the blade 30 can be similar in shape to the teeth described in U.S. Pat. No. 4,913,767 (the content whereof is incorporated herein by reference) and can be made by the method described in that patent. Points of the teeth 36 can pierce the tape and masking material composite 28 when that tape and masking material composite 28 is pulled across the teeth 36, and further tension applied to the tape and masking material composite 28 will cause the teeth 36 to further penetrate the tape and masking material composite 28 until it is completely severed by the cutting edge along the teeth 36. A blade guard (not illustrated) such as one of those described in U.S. Pat. Nos. 4,989,769, 6,367,533, or 6,786,376 (the contents whereof are incorporated herein by reference) can be used to protect a person using the dispenser 10 from the teeth 36 on the blade 30.

As is illustrated in FIG. 2, the removable pressure sensitive adhesive 40 on the masking material 25 can be in a longitudinal stripe 50 on a portion of the second major surface 42 of the masking material 25 adjacent and extending along its second edge 44. That stripe 50 should be at least 0.25 inch (0.64 cm) wide and is preferably at least 0.75 or 1 inch (1.9 or 2.54 cm) wide. Additionally, as illustrated the removable pressure sensitive adhesive could optionally also be in a second longitudinal stripe 51 extending along a central portion of the second major surface 42 of the masking material 25.

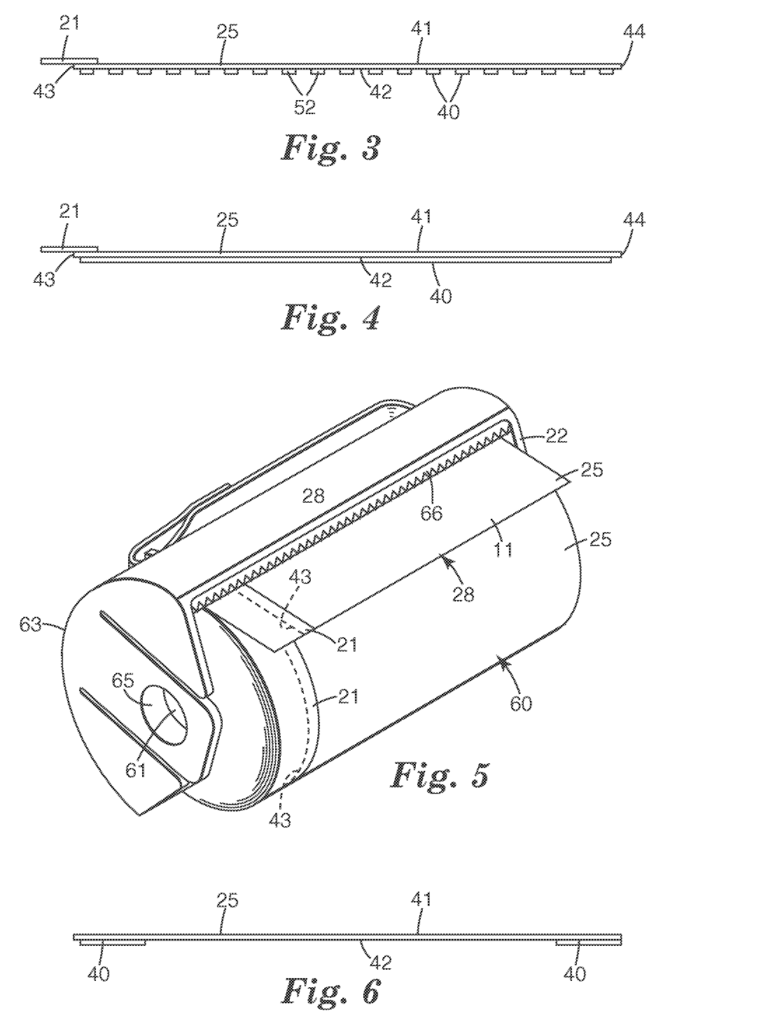

As illustrated in FIG. 3, the removable pressure sensitive adhesive 40′ on the second major surface 42 of the masking material 25 can alternatively be in spaced dots 52 of the adhesive 40′ over the entire second major surface 42 of the masking material 25, which spaced dots 52 could be more closely spaced or could be larger along the second edge 44 of the masking material 25. Also, though not illustrated, the dots 52 could be placed only on portions of the second major surface 42 of the masking material that are covered by the stripes 50 and 51 of the removable pressure sensitive adhesive illustrated in FIG. 2.

The stripes or dots or other configurations of removable pressure sensitive adhesive 40 on the second major surface 42 of the sheet of masking material 25 should extend over at least twenty five percent of the second major surface 42 of the masking material 25, and can extend over fifty percent of that second major surface 42.

As illustrated in FIG. 4, the removable pressure sensitive adhesive can extend entirely over the second major surface 42 of the masking material 25 which could be advantageous for some applications. One suitable material for use as the removable pressure sensitive adhesive 40 coated masking material 25 that comprises a backing layer of fibrous material and removable pressure sensitive adhesive extending entirely over one major surface is the material commercially available on a 3 inch (7.6 cm) core under the trade designation “3M SCPM-44X Premask Paper” from 3M Company, St. Paul, Minn. which for many years has been used as a premask for installing adhesive coated graphics, and has also been used alone as masking material, particularly in the marine repair industry.

The masking material 25 should have a width axially of the roll 24 of at least 4 inches (10.16 cm) and can have different widths axially of the roll 24 such as 6, 12, or 18 inches (15.2, 30.5, or 45.8 cm). The core 46 extends the entire width of the masking material 25 in the roll 24 and should be sufficiently stiff to support the masking material 25 on the roll 24 without bending or otherwise deforming as the masking material 25 is pulled from the dispenser 10, even though the core 4 projects past the hub 16 within its through opening (i.e., the hub 16 has an axial length of about 3 inches (7.6 cm)). A core 46 of fibrous or paper material having a wall thickness of at least 0.1 inch (0.254 cm) between its inner and outer surfaces 47 and 48 has been found suitable.

By stating that the sheet of masking material restricts absorption of liquids applied to its first major surface 41 we mean that a normal amount of liquid including water and solvent based paints applied to its first surface 41 will not be absorbed and pass to its second or inner major surface 42 before it dries so that the sheet of masking material 25 will normally protect a surface to which the masking material 25 is adhered from contact by that liquid.

As is illustrated in FIG. 5, the tape and masking material composite 28 with the tape 21 adhered to a first major surface 41 and along a first edge 43 of the sheet of masking material 25 can be provided in a roll 60 which includes a core 61 having an outer surface about which an innermost wrap of the roll of tape and masking material composite 28 is wrapped, and can be provided in combination with a dispenser 62 of the type comprising a housing 63 including means provided by a central part 64 of the housing 63 adapted for manual engagement, means provided by opposed trunnions 65 journaling the core 61 of the roll 60 for mounting the roll 60 of tape and masking material composite 28 for rotation about its axis relative to the housing 63, and means provided by a cutting blade 66 for severing a length of the tape and masking material composite 28 being manually withdrawn from the roll 60 of tape and masking material composite 28 (e.g., the illustrated dispenser described in U.S. Pat. No. 6,575,345, the content whereof is incorporated herein by reference, or a similar dispenser of the type included in the product commercially available under the trade designation “3M (t.m.) Handmasker (t.m.) Pre-Taped Drop Cloth” from 3M Company, St. Paul, Minn.).

Either of the dispensers 10 or 62 can also be used to dispense masking material 25 having removable pressure sensitive adhesive 40 on its second major surface 42 from a roll of the masking material 25 without having or applying the length of tape 21 along its first edge 43, in which case the removable pressure sensitive adhesive 40 should at least be on portions of that second surface 42 along both the first and second edges 43 and 44 of the sheet of masking material 25 as is illustrated in FIG. 6 to facilitate attaching that masking material 25 to a surface to be masked. Alternatively (not illustrated) the removable pressure sensitive adhesive 40 on such masking material 25 could extend over its entire second major surface.

The present invention has now been described with reference to several embodiments and possible modifications thereof. It will be apparent to those skilled in the art that many changes can be made in the embodiments described without departing from the scope of the present invention. Thus, the scope of the present invention should not be limited to the structures described in this application, but only by the structures described by the language of the claims and the equivalents thereof

What is claimed is:

1. A tape and masking material composite comprising an elongate sheet of masking material having opposite first and second major surfaces and first and second opposite edges between said major surfaces, and a length of pressure sensitive adhesive coated tape adhered to said first surface along said first edge of the sheet of masking material with the tape having a longitudinal pressure sensitive adhesive covered portion extending past said first edge of the sheet of masking material, said masking material having removable pressure sensitive adhesive on said second surface at least including on a portion of said second surface along said second edge.

2. A tape and masking material composite according to claim 1 wherein said removable pressure sensitive adhesive is coated in stripes on said second surface of said sheet of masking material.

3. A tape and masking material composite according to claim 1 wherein said removable pressure sensitive adhesive is coated in spaced dots on said second surface of said sheet of masking material.

4. A tape and masking material composite according to claim 1 wherein said removable pressure sensitive adhesive extends over at least twenty five percent of said second surface of said sheet of masking material.

5. A tape and masking material composite according to claim 1 wherein said removable pressure sensitive adhesive extends over at least fifty percent of said second surface of said sheet of masking material.

6. A tape and masking material composite according to claim 1 wherein said removable pressure sensitive adhesive extends entirely over said second surface of said sheet of masking material.

7. A tape and masking material composite according to claim 1 wherein said tape and masking material composite is in a helical roll about an axis with said first and second edges of said sheet of masking material being generally radially aligned around said axis, the roll of tape and masking material composite including a core having an outer surface about which an innermost wrap of the roll of tape and masking material composite is wrapped, and said roll of tape and masking material composite being in combination with a dispenser comprising a housing including means adapted for manual engagement, means for mounting the roll of tape and masking material composite for rotation about said axis relative to said housing, and means for severing a length of the tape and masking material composite manually withdrawn from the roll from the tape and masking material composite remaining in the roll.

8. A combination for use to mask a surface, said combination comprising:
a roll of material having an axis and first and second axially spaced ends, said roll of material comprising:
a stiff cylindrical core having an inner surface defining a through opening, and having a cylindrical outer surface;
an elongate thin sheet of flexible conformable masking material having opposite first and second major surfaces, and first and second opposite elongate edges, said masking material restricting absorption of liquids applied to said first major surface; and
removable pressure sensitive adhesive on said second major surface of said sheet of masking material at least including on portions of said second surface along said first and second edges,
said masking material being helically coiled about an outer surface of the core with the layer of adhesive adjacent the core; and
a portable dispensing apparatus comprising:
a frame including a portion of the frame adapted for manual engagement:
means on said frame receiving said roll of masking material for rotation about the axis of the roll relative to the frame; and
path defining means on said frame defining a path for said masking material being pulled from the dispensing apparatus; and
a cut off blade mounted on the frame, extending generally parallel to the axis of the hub, and defining a first side of said path, said cut off blade being adapted to transversely sever the masking material when the masking material is tensioned around a cutting edge on the blade as the masking material is being pulled away from the dispenser.

9. A combination according to claim 8 wherein said portion of the frame adapted for manual engagement is a handle projecting from the frame, and said means on said frame receiving said roll of masking material for rotation relative to the frame about the axis of the roll is a spindle mounted on the frame and having an end portion adapted to be inserted into the through opening of the core in frictional engagement with the inner surface defining the through opening in the core.

10. A combination according to claim 8 wherein said removable pressure sensitive adhesive is in stripes on said second surface of said sheet of masking material.

11. A combination according to claim 8 wherein said removable pressure sensitive adhesive is in spaced dots on said second surface of said sheet of masking material.

12. A combination according to claim 8 wherein said removable pressure sensitive adhesive extends over at least twenty five percent of said second surface of said sheet of masking material.

13. A combination according to claim 8 wherein said removable pressure sensitive adhesive extends over at least fifty percent of said second surface of said sheet of masking material.

14. A combination according to claim 8 wherein said removable pressure sensitive adhesive extends entirely over said second surface of said sheet of masking material.

15. A combination according to claim 8 wherein said masking material has a width axially of said roll of at least 4 inches (10.2 cm).

16. A combination of:
a roll of masking material having an axis and first and second axially spaced ends, said roll of masking material comprising:
a stiff cylindrical core having a through opening, and a cylindrical outer surface;
the elongate, thin, flexible, conformable masking material having opposite first and second major surfaces and opposite longitudinally extending first and second opposite edges, said masking material restricting absorption of liquids applied to said first major surface, and
a coating of removable pressure sensitive adhesive on said second major surface of the sheet of masking material at least including on a portion of said second surface along said second edge,
said masking material being helically coiled about an outer surface of the core with the layer of removable adhesive adjacent the core;
a roll of pressure sensitive adhesive coated tape having longitudinally extending first and second opposite edges; and
a portable dispensing apparatus comprising:
a frame;
a handle mounted on the frame adapted for manual engagement:
first and second hubs mounted on said frame for rotation about spaced generally parallel axes, said first hub receiving the roll of tape and positioning a first edge of a length of the tape withdrawn from the roll at a first predetermined position axially with respect to the first and second hubs, the second hub receiving the roll of masking material and positioning a first end of the roll of masking material at a second predetermined position axially with respect to the first and second hubs with the width of the length of tape extending from the first position past the second position and the roll of masking material extending from the second position past the first position, a portion of the length of tape along the first edge of the length of tape and a portion of the length of masking material along the first end of the roll of material both being positioned between said first and second positions, said dispenser including means defining a path for the length of tape from the roll of tape to the periphery of the roll of masking material where the portion of tape along the first edge of the length of tape is adhered to the portion of the masking material along the first end of the roll of masking material, such adhesion of the tape to the masking material along the periphery of the roll of making material forming a tape and masking material composite having opposite edges defined by the second edges of the length of tape and the length of masking material and an exposed portion of the coating of pressure sensitive adhesive along the second edge on the length of tape along one major surface of the tape and masking material composite so that the exposed portion of the coating of adhesive can be adhered along a surface to be masked to hold the tape and masking material composite in a desired position;
path defining means on said frame defining a path for said tape and masking material composite being pulled from the dispensing apparatus; and
a cut off blade mounted on the frame, extending generally parallel to the axis of the hub, and defining a first side of said path, said cut off blade being adapted to transversely sever the tape and masking material composite when the tape and masking material composite is tensioned around a cutting edge on the blade as the tape and masking material composite is pulled away from the dispenser.

17. A combination according to claim 16 wherein said removable pressure sensitive adhesive is in stripes on said second surface of said sheet of masking material.

18. A combination according to claim 16 wherein said removable pressure sensitive adhesive is in spaced dots on said second surface of said sheet of masking material.

19. A combination according to claim 16 wherein said removable pressure sensitive adhesive extends over at least twenty five percent of said second surface of said sheet of masking material.

20. A combination according to claim 16 wherein said removable pressure sensitive adhesive extends over at least fifty percent of said second surface of said sheet of masking material.

21. A combination according to claim 16 wherein said removable pressure sensitive adhesive extends entirely over said second surface of said sheet of masking material.
